(19) United States
(12) Patent Application Publication
(10) Pub. No.: US 2016/0163147 A1
(43) Pub. Date: Jun. 9, 2016

(54) GAME CREATION PROCESS AND APPARATUS

(71) Applicant: Thomas William Dorsher, Oakes, ND (US)

(72) Inventor: Thomas William Dorsher, Oakes, ND (US)

(21) Appl. No.: 14/560,903

(22) Filed: Dec. 4, 2014

(51) Int. Cl. G07F 17/32

(52) U.S. Cl. CPC G07F 17/329; G07F 17/3225

(57) ABSTRACT

A game creation process and a game creation apparatus for creating and customizing a game of chance are disclosed. Some embodiments provide a set of tools and utilities to create a game that employs a bingo or classical card or board game format and which utilizes any combination of digital content, trivia questions, physical challenges, and traditional bingo or card game formats. Some embodiments include a built-in card generator that randomizes, creates and prints game cards and allows a user to specify fonts, font colors, backgrounds, gradients, size, quantity, black and white or color printing, and other such settings.

### BACKGROUND

Embodiments of the invention described in this specification relate generally to game creation, and more particularly, to game creation tools and processes.

Videos, picture slide shows, and other types of media file content are often important sources of entertainment at social gatherings. One type of activity that occurs at many social gatherings is a game of bingo or participants playing another classical card or board game. The traditional game of bingo includes a card having various number arranged in a matrix. An announcer calls out letter and number combinations, and the first player to match a set of number according to a designated pattern wins. Unfortunately, the classic game of bingo is usually required to be played in substantial silence to allow players to hear the numbers being called out by an announcer during a bingo game. Thus, much of the possible media file content that could enliven social gatherings goes absent when a classical game, such as bingo, is being played. This is a drawback to participants of such classical games.

The problem of not utilizing media content to its fullest is further exacerbated by the fact that other systems in this field only support audio file recordings and are not game creation engines, but instead are merely the actual final composite games (not a method or system to make the game). None of the options provide a tool for users to manage any digital media file type or trivia questions and convert the digital media into a bingo style game or other such classic board game and/or card game. This worsens the existing problem in which media content is underutilized. Also, the existing systems and games in the field do not include a bingo card or game card generator for randomizing and printing bingo or game cards.

Therefore, what is needed is a way to create more exciting versions of games, such as a classical a bingo game which utilizes additional media content, or another classic board game and/or card that is enhanced by the addition of other media content.

### BRIEF DESCRIPTION

Some embodiments of the invention include a novel game creation process for combining media files and content with a traditional game. In some embodiments, the media files and content comprise pictures, video clips, audio clips, and other types of media content. In some embodiments, the traditional game is bingo. In some embodiments, traditional game is at least one of bingo, chess, checkers, go fish, a trivia game, a card game, a board game, a betting game, a physical relay race, and a physical movement game.

In some embodiments, the game creation process includes (i) receiving user input and a set of media file content, (ii) storing the received input and content in a catalog database under a unique name, (iii) generating a set of game playing elements based on user preferences, (iv) randomizing the generated set of game playing elements prior to starting play of the game for a specified period of time, and (v) tracking scores of participants playing the game.

In some embodiments, the game creation process is implemented on a game apparatus with a computing hardware architecture and memory.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a game creation process for creating a classical card or board game in some embodiments.

FIG. 2 conceptually illustrates a continuation of the game creation process for creating a classical card or board game shown in FIG. 1.

FIG. 3 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel game creation process for combining media files and content with a traditional game. In some embodiments, the media files and content comprise pictures, video clips, audio clips, and other types of media content. In some embodiments, the traditional game is bingo. In some embodiments, traditional game is at least one of bingo, chess, checkers, go fish, a trivia game, a card game, a board game, a betting game, a physical relay race, and a physical movement game.

In some embodiments, the game creation process includes (i) receiving user input and a set of media file content, (ii) storing the received input and content in a catalog database under a unique name, (iii) generating a set of game playing elements based on user preferences, (iv) randomizing the generated set of game playing elements prior to starting play of the game for a specified period of time, and (v) tracking scores of participants playing the game.

As stated above, the traditional game of bingo includes a card having various number arranged in a matrix. An announcer calls out letter and number combinations, and the first player to match a set of number according to a designated pattern wins. Videos, picture slide shows, and other types of media file content are often important sources of entertainment at social gatherings. Unfortunately, the classic game of bingo is usually required to be played in substantial silence to allow players to hear the numbers being called out by an announcer during a bingo game.

Embodiments of the invention described in this specification solve such problems by way of a game creation process that provides a set of tools and utilities to create a game that employs a bingo or classical card or board game format and which utilizes any combination of digital content, trivia questions, physical challenges, and traditional bingo or card game formats. In some embodiments, the game creation process is implemented as a game creation software program that runs on a computing device. Additionally, the game creation software program has a built in bingo card generator for randomizing, creating and printing bingo cards and allows the user to specify fonts, font colors, backgrounds, gradients, size, quantity, black and white or color printing, and other such preferences and settings.

The embodiments described in this specification differ from and improve upon currently existing options. In particular, some embodiments differ because the game creation software program provides a set of tools to manage any form of content or media component, such as a set of pictures in whole or in part, a set of video files in whole or in part, multiple trivia questions and answers, and other media file type formats that can be stored on a computer. None of the existing systems includes any of such tools to manage all forms of digital content and arrange them for a bingo style or classic board game and/or card game format.

In addition, these embodiments improve upon the currently existing options because other devices in this field only support audio recordings. Management for videos, pictures, trivia questions, and physical challenge instructions are not supported and are typically limited in scope to a bingo format only. In contrast, the game creation software program, which is not an actual game, provides users the tools, or utilities, to create a game that employs the creation of a bingo format utilizing any combination of digital content, trivia questions, physical challenges, traditional bingo formats, classic and contemporary board games, and card games. Additionally, the game creation software program has a built in bingo card generator for randomizing, creating and printing bingo cards and allows the user to specify fonts, font colors, backgrounds, gradients, size, quantity, black and white or color printing. Moreover, the game creation software program tool further includes a graphical user interface (GUI) for users to customize, create and also print bingo cards. Such bingo cards can be configured in a 1×1 matrix or a 20×20 matrix, or anything in between.

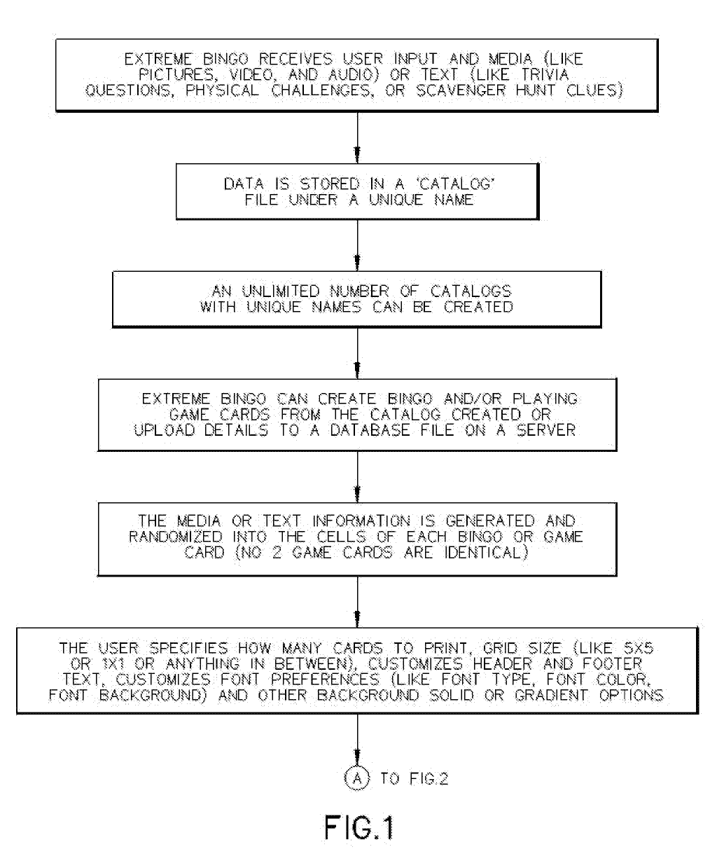

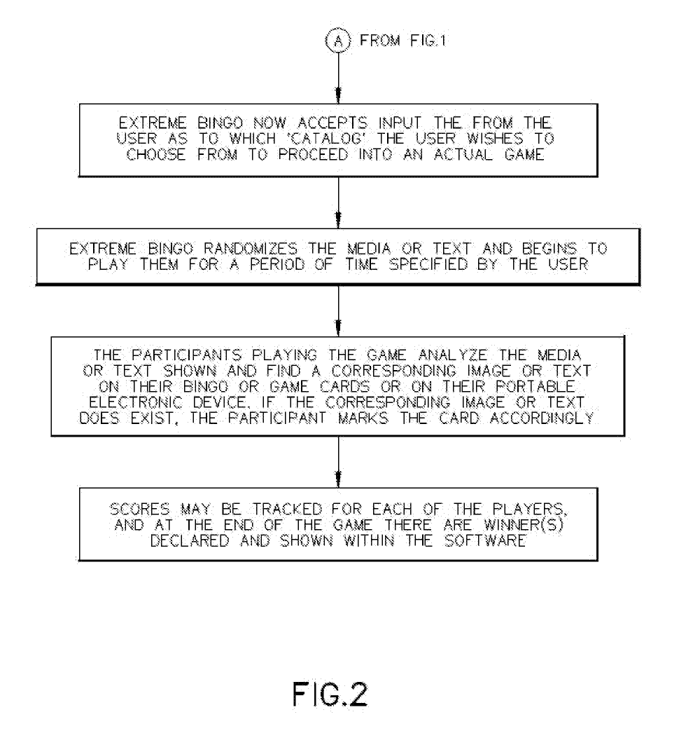

By way of example, FIGS. 1 and 2 conceptually illustrate a game creation process for creating a classical card or board game. The game creation process may be comprised of the following steps when implemented as a game creation software program and run on a computing device. In some embodiments, the game creation software program is known as Extreme Bingo. However, any name can be substituted to suit any type of classical game being created. Thus, the name of the program and the following list of possible constituent steps is intended to be exemplary only and it is not intended that this list be used to limit the game creation process of the present application to just these steps or just the Extreme Bingo name when implemented as a game creation software program. Persons having ordinary skill in the art relevant to the present disclosure may understand there to be equivalent steps and/or names that may be substituted within the present disclosure without changing the essential function or operation of the game creation process.

1. The game creation software program receives user input and media (e.g., pictures, video clips, audio files, etc.) or textual input (e.g., trivia questions, physical challenges, scavenger hunt clues, etc.).

2. The game creation software program stores the received input, media, and/or textual input in a ‘catalog’ that is assigned a unique name.

3. The game creation software program receives user input related to creating bingo or other game cards, such as how many cards to print, a playing sheet grid size (e.g., a 1×1 matrix or a 20×20 matrix or anything in between), custom header and/or footer text, custom font preferences (like font type, font color, font background) and other background solid or gradient options.

4. Based on the user input for card creation, the game creation software program then creates bingo and/or game playing cards from the associated catalog, or uploads details to a database file on a server. Also, the game creation software program has its own unique bingo card generator that randomizes the media or text information into the cells of each bingo card or other game card, and also ensures that there are no 2 identical game cards.

5. The game creation software program receives a user input specifying a number for a quantity of cards to generate and print (e.g., to a local printer) or upload to a database that is connected to a server on a network.

6. The game creation software program receives a user input specifying a ‘catalog’ from which the user wishes to play a game.

7. The game creation software program randomizes the media or text and begins to play the game with them for a period of time specified by the user.

8. The participants playing the game analyze the media or text shown and find a corresponding image or text on their game cards or bingo cards, or in some cases, on a mobile computing device that displays bingo or game cards for the game, resulting in a participant action such that if the corresponding image or text does exist, the participant marks the card accordingly.

9. Step 8 of the process can repeat where media or text is shown and participants analyze their bingo cards for a corresponding image or text. When a participant shouts bingo! then the user checks their bingo card to confirm if a bingo exists. If so, then the game is over (or can be continued by the user so as to have multiple winners).

10. Scores may be tracked for each of the players, and at the end of the game there may be one or more winners declared and shown within an interface of the software program. When the user is finished with the series of bingo games, the user then exits the program. The previously created catalogs and bingo card data are all stored internally for future use at a later time to play the same game(s) again.

The game creation process of the present disclosure generally works by a computer software program (e.g., Extreme Bingo game creation software program) that runs on a computing device and functions according to implemented programming and user preferences.

To make the game creation software program which implements the game creation process of the present disclosure, a person would have to have a deep knowledge of programming, database reading/writing, server communications, MySQL, scanning for files, sending a print job to a connected printer, playing or displaying media like pictures, video, and audio files. The game creation software program receives input and media from the user and stores the input and media into a ‘catalog’ which is later used to generate and print bingo cards and other classic game cards and other game items for the players.

To use the game creation process of the present disclosure, unfortunately, a person would interact with a graphical user interface (GUI) of the game creation software program and specify settings and select media content files capable of creating a more exciting version of a classic game.

In some embodiments, the game creation process is implemented on a game apparatus as described herein. The game apparatus includes a digital memory storage apparatus configured to store a plurality of trivia question or media, wherein each media file includes a portion of a professional released recording of a song or video or picture wherein such song or video file includes an identifiable and publicly-known title, a sound generation apparatus for broadcasting at least a portion of the plurality of musical or video recordings as mechanical waves, a controller controlling the broadcasting of the at least a portion of the plurality of musical or video recordings as mechanical waves, and a plurality of playing cards for game participants, each playing card including a matrix of song titles, each playing card including a different selection and orientation of the song titles, where the song titles included on the whole of the plurality of playing cards are the same as the identifiable and publicly-known titles of the professional released recordings of songs defining the plurality of music or video recordings, or pictures or trivia.

Also, it can create: The game creation software program tool further includes an graphical user interface for users to customize, create and also print bingo cards. Such bingo cards can be configured in a 1×1 matrix or a 20×20 matrix, or anything in between.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors), they cause the processing unit(s) to perform the actions indicated in the instructions. Examples of computer readable media include, but are not limited to, CD-ROMs, flash drives, RAM chips, hard drives, EPROMs, EEPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

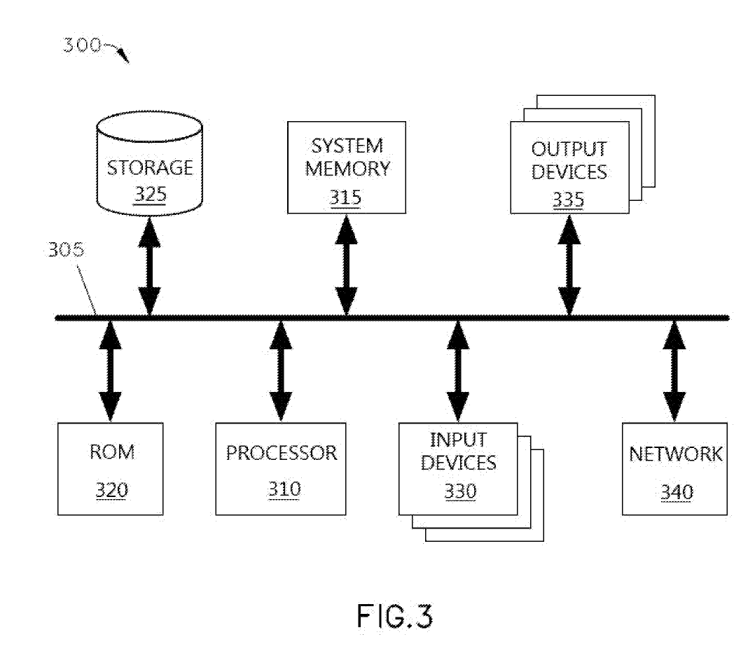

FIG. 3 conceptually illustrates an electronic system 300 with which some embodiments of the invention are implemented. The electronic system 300 may be a computing device, such as a desktop computer, a laptop computer, a tablet computing device, a portable hand-held computing device, a portable communications devices (such as a mobile phone), a personal digital assistant (PDA) computing device, or any other sort of electronic device. Such an electronic system includes various types of computer readable media and interfaces for various other types of computer readable media. Electronic system 300 includes a bus 305, processing unit(s) 310, a system memory 315, a read-only 320, a permanent storage device 325, input devices 330, output devices 335, and a network 340.

The bus 305 collectively represents all system, peripheral, and chipset buses that communicatively connect the numerous internal devices of the electronic system 300. For instance, the bus 305 communicatively connects the processing unit(s) 310 with the read-only 320, the system memory 315, and the permanent storage device 325.

From these various memory units, the processing unit(s) 310 retrieves instructions to execute and data to process in order to execute the processes of the invention. The processing unit(s) may be a single processor or a multi-core processor in different embodiments.

The read-only-memory (ROM) 320 stores static data and instructions that are needed by the processing unit(s) 310 and other modules of the electronic system. The permanent storage device 325, on the other hand, is a read-and-write memory device. This device is a non-volatile memory unit that stores instructions and data even when the electronic system 300 is off. Some embodiments of the invention use a mass-storage device (such as a magnetic or optical disk and its corresponding disk drive) as the permanent storage device 325.

Other embodiments use a removable storage device (such as a floppy disk or a flash drive) as the permanent storage device 325. Like the permanent storage device 325, the system memory 315 is a read-and-write memory device. However, unlike storage device 325, the system memory 315 is a volatile read-and-write memory, such as a random access memory. The system memory 315 stores some of the instructions and data that the processor needs at runtime. In some embodiments, the invention's processes are stored in the system memory 315, the permanent storage device 325, and/or the read-only 320. For example, the various memory units include instructions for processing appearance alterations of displayable characters in accordance with some embodiments. From these various memory units, the processing unit(s) 310 retrieves instructions to execute and data to process in order to execute the processes of some embodiments.

The bus 305 also connects to the input and output devices 330 and 335. The input devices enable the user to communicate information and select commands to the electronic system. The input devices 330 include alphanumeric keyboards and pointing devices (also called “cursor control devices”). The output devices 335 display images generated by the electronic system 300. The output devices 335 include printers and display devices, such as cathode ray tubes (CRT) or liquid crystal displays (LCD). Some embodiments include devices such as a touchscreen that functions as both input and output devices.

Finally, as shown in FIG. 3, bus 305 also couples electronic system 300 to a network 340 through a network adapter (not shown). In this manner, the computer can be a part of a network of computers (such as a local area network (“LAN”), a wide area network (“WAN”), or an Intranet), or a network of networks (such as the Internet). Any or all components of electronic system 300 may be used in conjunction with the invention.

The functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1-2 conceptually illustrate processes in which the specific operations of each process may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a game creation software program which when executed by at least one processing unit of a computing device generates game elements of a classical game, said program comprising sets of instructions for:
receiving a set of user preferences and a set of media content to be used on game elements associated with play of a classical game;
storing the set of user preferences and the set of media content in a catalog database;
receiving an input specifying a number of game elements required for play of the classical game;
generating the number of game elements with at least one of the user preferences and the set of media content; and
randomizing the number of game elements to start a new game for a set of participants playing the classical game.

2. The non-transitory computer readable medium of claim 1, wherein the classical game is bingo.

3. The non-transitory computer readable medium of claim 1, wherein the classical game is a card game.

4. The non-transitory computer readable medium of claim 1, wherein the classical game is a board game.

5. The non-transitory computer readable medium of claim 1, wherein the program further comprises a set of instructions for tracking scores of the participants during play of the classical game.

6. The non-transitory computer readable medium of claim 1, wherein the catalog database has a unique name.

7. The non-transitory computer readable medium of claim 1, wherein the set of instructions for receiving the set of user preferences and the set of media content to be used on game elements comprises a set of instructions for receiving textual input to be used on game elements.

8. The non-transitory computer readable medium of claim 7, wherein the textual input comprises at least one of a trivia question, a description of a physical challenge, and a scavenger hunt clue.

9. The non-transitory computer readable medium of claim 1, wherein the set of media content to be used on game elements comprises at least one of a picture, a video clip, and an audio clip.

10. The non-transitory computer readable medium of claim 1, wherein the user preferences comprise at least one of printable header information, printable footer information, a font type, a font color, a font background, a grid size, and a gradient option.
